(19) United States
(12) Patent Application Publication
(10) Pub. No.: US 2007/0296917 A1
(43) Pub. Date: Dec. 27, 2007

(54) TINTED CONTACT LENSES HAVING IRIS PATTERNS WITH ENHANCED DEPTH

(76) Inventors: Jackie W. Bowers, Jacksonville, FL (US); Karin D. McCarthy, Ponte Vedra Beach, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/426,038

(22) Filed: Jun. 23, 2006

(51) Int. Cl. G02C 7/04

(52) U.S. Cl. 351/162

(57) ABSTRACT

The invention provides tinted contact lenses having a pattern that has an appearance of added depth when compared to conventional patterns and a more natural appearance to the pattern when the lens is worn on-eye.

### FIELD OF THE INVENTION

The invention relates to tinted contact lenses. In particular, the invention provides contact lenses with iris patterns that either enhance or change the color of a lens wearer's iris and which patterns have an appearance of depth.

### BACKGROUND OF THE INVENTION

The use of tinted, or colored, contact lenses to either or both alter the natural color of the iris and to mask ophthalmic abnormalities is well known. Typically, these lenses use either or both opaque and translucent colors to change the color of an iris, as for example, from brown to blue. Additionally, tinted lenses have been manufactured that attempt to enhance the color of a dark-eyed person without changing the color of the iris. The conventional tinted lenses are disadvantageous in that they lack the three-dimensional appearance of the natural iris. This results in a flat, unnatural appearance when the lens is worn on-eye.

### BRIEF DESCRIPTION OF THE DRAWINGS

FIG. 1 is a pattern for use in the invention.

FIG. 2 is a second pattern for use in the invention.

FIG. 3 is a pattern of the invention composed of the patterns of FIGS. 1 and 2.

### DETAILED DESCRIPTION OF THE INVENTION AND PREFERRED EMBODIMENTS

The invention provides tinted contact lenses, and methods for their manufacture, that enhance the color of the lens wearer's iris. The lenses of the invention have a pattern that has an appearance of added depth when compared to conventional patterns and a more natural appearance to the pattern when the lens is worn on-eye. The lenses of the invention will find utility as cosmetic lenses for either or both enhancing an individual's iris color or changing the color of the iris.

In one embodiment, the invention provides a contact lens comprising, consisting essentially of, and consisting of at least one first pattern comprising a first color and a first shape and at least a second pattern capable of imparting a shadow-effect to the first pattern.

It is a discovery of the invention that an appearance of depth may be imparted to a tinted pattern of a contact lens by use of one or more pattern layers that impart a shadow-effect to another pattern layer of the lens. By “shadow-effect” is meant that one or more layers of patterns resemble a shadow of a pattern of another layer of the lens.

The shadow-effect may be achieved by any convenient method. For example, a first pattern having a first color and a first shape may be provided. A second pattern having a second color and the shape of the first pattern is then provided. When printed onto or incorporated into the lens, one of the first and second patterns overlays the other pattern, but the rotational position of one of the patterns is offset from that of the other.

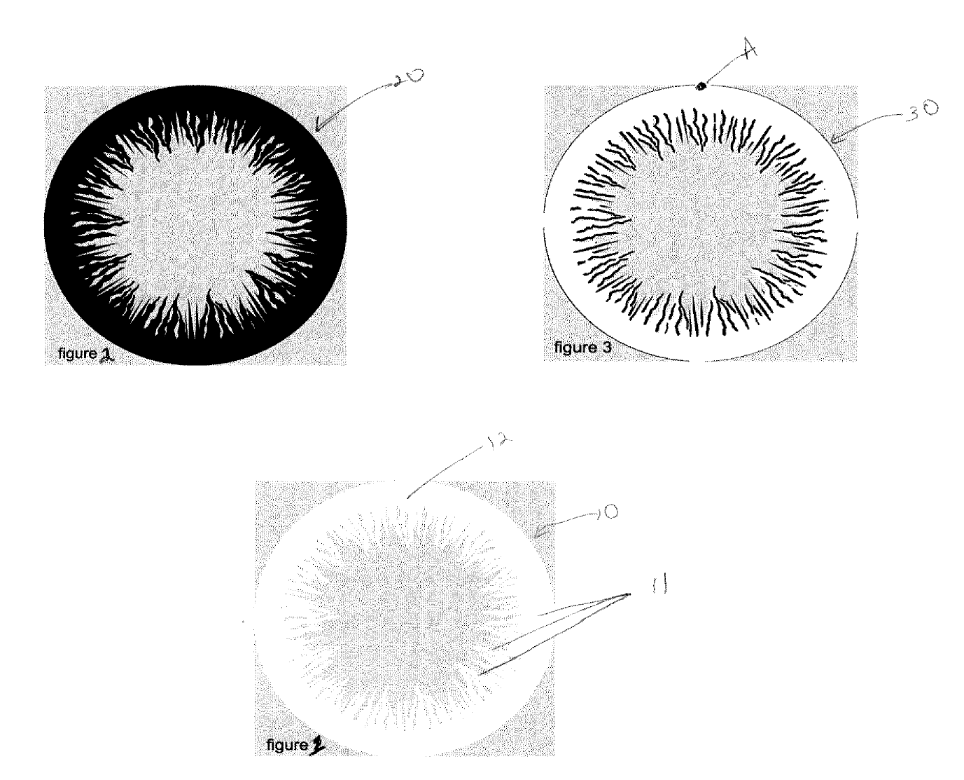

This method is illustrated in FIGS. 1, 2 and 3. In FIG. 1 is pattern 10 having a first color and a first shape. One will recognize that the first shape is the result of a plurality of pattern elements 11 and a solid band of color 12. Pattern 10 may be of a size so that it composes substantially the entire iris portion of the lens, or portion of the lens that overlies the wearer's iris, while the lens is on-eye and centered. Alternatively, pattern 10 may be of a size so that it composes a portion of the iris portion of the lens. In FIG. 2 is shown pattern 20, which pattern is of a second color, but has the size and shape of pattern 10. Thus, pattern 20 is substantially identical to pattern 20 except in color. Pattern 20 may be printed onto a surface of a lens by known methods. Pattern 10 is then printed onto the lens surface so that it overlays pattern 20, but pattern 10 is offset by rotating it between about 0.025 mm and 1.00 mm clockwise or counterclockwise relative to the 90 degree point on the lens, Point A, of FIG. 3. The result as shown in FIG. 3 is that the darker colored pattern 10 appears to impart a shadow to pattern 20.

As an alternative, a first and second layer of patterns may be printed onto a lens. Portions of the top-most layer pattern are omitted so that underlying portions of the other pattern are rendered visible. Yet another method of producing a shadow-effect is by providing a first pattern and a second pattern that is composed of elements that, when combined with the first pattern, result in providing a shadow-effect to all or a portion of the elements of the first pattern without the need for offsetting.

The patterns used in the invention may include any of a number of components. The components may include, without limitation, geometric structures, such as dots and lines, or fanciful structures including, without limitation, striae, feather-like shapes, and the like, and combinations thereof. A limbal ring may be added to form the outermost periphery of the pattern. By “limbal ring” is meant an annular band of color that, when the lens is on-eye and centered, partially or substantially completely overlies the lens wearer's limbal region, or the junction of the sclera with the cornea. Preferably, the limbal ring substantially completely overlies the wearer's limbal region. The innermost border, or edge closest to the geometric center of the lens, of the limbal ring may be at a radius of about 4 mm to about 6 mm, preferably about 4.5 to about 5.5 mm, from the lens'geometric center. The ring may be of any suitable width and preferably is about 0.5 to about 2.5 mm in width, more preferably about 0.75 to about 1.25 mm in width.

In any of the patterns of the invention, the pupil portion preferably is clear. However, the pupil portion may be an area of translucent or opaque color or any combination of opaque and translucent colors.

Preferably, the elements of the pattern are of an opaque color. Alternatively, the elements may be translucent, or a combination of translucent and opaque elements may be used depending on the desired on-eye result. For purposes of the invention, by “translucent” is meant a color that permits an average light transmittance (% T) in the 380 to 780 nm range of about 60 to about 99%, preferably about 65 to about 85% T. By “opaque” is meant a color that permits an average light transmittance (% T) in the 380 to 780 nm range of 0 to about 55, preferably 7 to about 50% T. Similarly, additional elements of the pattern may be opaque, translucent or a combination thereof

The color of the pattern used to impart the shadow-effect preferably is of a darker color than the other pattern. More preferably, the shadow-effect imparting pattern is of a darker and complementary color when compared to the color of the other pattern. Preferably, all elements of a pattern are of the same color and the pupil portion is clear, meaning that it is colorless.

The color selected for each of the patterns will be determined by the natural color of the lens wearer's iris and the enhancement or color change desired. Thus, patterns may be any color including, without limitation, any of a variety of hues and chromas of blue, green, gray, brown, black yellow, red, or combinations thereof. Preferred colors for the limbal ring include, without limitation, any of the various hues and chromas of black, brown and gray.

The elements, may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange #1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a pre-polymer, or binding polymer, and a solvent to form the colorant used to produce the translucent and opaque layers used in the lenses of the invention. Other additives useful in contact lens colorants also may be used. The binding polymers, solvents, and other additives useful in the color layers of the invention are known and either commercially available or methods for their making are known.

The patterns may be incorporated into a contact lens by any convenient method including, without limitation, printing on one or more surfaces of a lens or printing onto one or more surfaces of a mold into which a lens forming material will be deposited and cured. In a preferred method for forming lenses incorporating the designs of the invention, a thermoplastic optical mold, made from any suitable material including, without limitation, cyclic polyolefins and polyolefins such as polypropylene or polystyrene resin is used. The elements are deposited onto the desired portion of the molding surface of the mold. By “molding surface” is meant the surface of a mold or mold half used to form a surface of a lens. The deposition may be carried out by spraying, pad printing, tampo printing, brushing or stamping. Preferably, the deposition is carried out by pad printing as follows.

A metal plate, preferably made from steel and more preferably from stainless steel, is covered with a photo resist material that is capable of becoming water insoluble once cured. The elements are selected or designed and then reduced to the desired size using any of a number of techniques such as photographic techniques, placed over the metal plate, and the photo resist material is cured.

The plate is subsequently washed with an aqueous solution and the resulting image is etched into the plate to a suitable depth, for example about 20 microns. A colorant containing a binding polymer, solvent, and pigment or dye is then deposited onto the elements to fill the depressions with colorant. A silicon pad of a geometry suitable for use in printing on the surface and varying hardness, generally about 1 to about 10, is pressed against the image on the plate to remove the colorant and the colorant is then dried slightly by evaporation of the solvent. The pad is then pressed against the molding surface of an optical mold. The mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

In a preferred embodiment, a clear, pre-polymer layer is used, which pre-polymer layer overlays at least the pattern elements and preferably forms the entirety of the lens' outermost surface. The pre-polymer may be any polymer that is capable of dispersing the pigment and any opacifying agent used and may be applied over the pattern elements once the elements are incorporated into the lens. Alternatively, the pre-polymer layer may be printed onto the molding surface of a lens mold prior to application of the pattern elements to the mold. The invention may be used to provide hard or soft contact lenses made of any known lens material, or material suitable for manufacturing such lenses. Preferably, the lenses of the invention are soft contact lenses having water contents of about 0 to about 90 percent. More preferably, the lenses are made of monomers containing hydroxy groups, carboxyl groups, or both or be made from silicone-containing polymers, such as siloxanes, hydrogels, silicone hydrogels, and combinations thereof. Material useful for forming the lenses of the invention may be made by reacting blends of macromers, monomers, and combinations thereof along with additives such as polymerization initiators. Suitable materials include, without limitation, silicone hydrogels made from silicone macromers and hydrophilic monomers. Examples of such silicone macromers include, without limitation, polydimethylsiloxane methacrylated with pendant hydrophilic groups; polydimethylsiloxane macromers with polymerizable function; and combinations thereof. They may also be made using polysiloxane macromers incorporating hydrophilic monomers; or macromers comprising polydimethylsiloxane blocks and polyether blocks.

Suitable materials also may be made from combinations of oxyperm and ionoperm components. Hydrophilic monomers may be incorporated into such copolymers, including 2-hydroxyethyl methacrylate (“HEMA”), 2-hydroxyethyl acrylate, N,N-dimethylacrylamide (“DMA”), N-vinylpyrrolidone, 2-vinyl-4,4′-dimethyl-2-oxazolin-5-one, methacrylic acid, and 2-hydroxyethyl methacrylamide. Additional siloxane monomers may be incorporated such as tris(trimethylsiloxy)silylpropyl methacrylate, or the siloxane monomers. They may also include various toughening agents, UV blockers, and wetting agents. They can be made using diluents such as primary alcohols, or the secondary or tertiary alcohols.

The materials for making the contact lenses are well known and commercially available. In one non-limiting embodiment, the material used is a HEMA based hydrogel, more preferably etafilcon A, and the binding polymer is formed from linear random block copolymers of MAA, HEMA and lauryl methacrylate (“LMA”); linear random block copolymers of MAA and HEMA; linear random block copolymers of HEMA and LMA; or a HEMA homopolymer. Etafilcon A, generally is a formulation of 100 parts by weight (“pbw”) HEMA, about 1.5 to about 2.5 pbw MAA, approximately 0.3 to about 1.3 pbw ethylene glycol dimethacrylate, about 0.05 to about 1.5 pbw 1,1,1,-trimethylolpropane trimethacrylate, and about 0.017 to about 0.024 pbw of a visibility tint. Preferably etafilcon A is used with a linear random block copolymer of MAA, HEMA and LMA in a ratio of 0.47 MAA to 100 HEMA to 4.14 LMA, or with a linear random block copolymer of HEMA and MAA in a ratio of 99.9 HEMA and 0.1 MAA to 99.5 HEMA and 0.5 MAA.

1. A contact lens, comprising of at least one first pattern having a first color and a first shape and at least a second pattern having a second color and a second shape, wherein one of the first or second patterns is offset in relation to the other pattern by between about 0.025 mm and 1.00 mm in clockwise or counterclockwise rotation relative to the 90 degree point on the lens.

2. The contact lens of claim 1, wherein the second shape is the same as the first shape.

3. The contact lens of claim 1, wherein the second shape is different from the first shape.

4. The contact lens of claim 1, wherein the first and second pattern are of a size so that they comprise substantially an entire iris portion of the lens.

5. The contact lens of claim 1, wherein the first and second pattern are of a size so that they comprise a portion of an iris portion of the lens.

6. The contact lens of claim 2, wherein the first and second pattern are of a size so that they comprise substantially an entire iris portion of the lens.

7. The contact lens of claim 2, wherein the first and second pattern are of a size so that they comprise a portion of an iris portion of the lens.

8. The contact lens of claim 3, wherein the first and second pattern are of a size so that they comprise substantially an entire iris portion of the lens.

9. The contact lens of claim 3, wherein the first and second pattern are of a size so that they comprise a portion of an iris portion of the lens.

10. The contact lens of claim 1, wherein the second color is of a darker color than the first color.

11. The contact lens of claim 2, wherein the second color is of a darker color than the first color.

12. The contact lens of claim 3, wherein the second color is of a darker color than the first color.

13. The contact lens of claim 1, wherein the lens further comprises a limbal ring.

14. A method of forming a tinted contact lens, comprising the steps of:
a.) providing at least one first pattern having a first color and a first shape;
b.) providing at least a second pattern having a second color and a second shape, wherein the rotational position of one of the first or second patterns is offset in relation to the other pattern by rotating one of the first or second patterns between about 0.025 mm and 1.00 mm clockwise or counterclockwise relative to the 90 degree point on the lens.

15. (canceled)

16. (canceled)

17. (canceled)
